(19) United States
(12) Patent Application Publication
(10) Pub. No.: US 2010/0123666 A1
(43) Pub. Date: May 20, 2010

(54) USER-MODIFIABLE CASING FOR PORTABLE COMMUNICATION DEVICES

(75) Inventors: Anna Wickholm, Malmo (SE); Ola Thorn, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/273,688

(22) Filed: Nov. 19, 2008

(51) Int. Cl. G06F 3/041; G09G 3/00

(52) U.S. Cl. 345/173; 345/30

(57) ABSTRACT

The invention relates to a casing for a portable communication device, comprising at least one layer of an electrical conducting material adapted to change its appearance. The layer is connected to an outer surface of the casing. A control unit is adapted to receive an input signal and as a result produce a control signal where the layer is adapted to receive the control signal and to change its appearance depending on the control signal, and thereby change the appearance of said casing.

### TECHNICAL FIELD

The present invention relates to the field of portable electronic devices and, in particularly, to user-modifiable casings for such devices. The present invention especially targets the area of portable mobile communication devices, such as mobile phones, where user-modifiable casings are highly sought for.

### BACKGROUND

Long gone are the days when only the technical features were the deciding factor when buying a portable communication device such as mobile phone. In recent years the design and look of these devices has become increasingly important to the customer. Additionally, the user's of these device often wants to be able to influence the design them self to better reflect their personality, or even their current mood. However, the existing ways to personalize the design and appearance of a portable communication device are today limited to buying expensive exchangeable cover parts or stickers, and even then the number of ways to change the appearance of the device is quite limited. Therefore, finding a way to be able to personalize and tailor the appearance of a portable electronic device, such as a mobile phone, in a more limitless and inexpensive way would be most welcome.

### SUMMARY OF THE INVENTION

With the above description in mind, then, an aspect of the present invention is to provide an inexpensive user-modifiable casing which seeks to mitigate, alleviate, or eliminate one or more of the above-identified deficiencies in the art and disadvantages singly or in any combination.

As will be described in more detail by the aspects of the present invention below, one way to provide such user-modifiable casing is to cover the casing with an electrical conducting material which is capable of changing its appearance in such way that it also changes the overall appearance of the casing and thereby the mobile phone.

A first aspect of the present invention relates to a casing for a portable communication device, comprising at least one layer of an electrical conducting material adapted to change its appearance, wherein said layer is connected to an outer surface of said casing, a control unit adapted to receive an input signal and as a result produce a control signal, wherein said layer is adapted to receive said control signal and to change its appearance depending on said control signal, and thereby change the appearance of said casing.

The layer of electrical conducting material may further comprise of a number of individual cells, wherein each individual cell is capable of changing its appearance individually depending on said control signal.

The change of appearance of the casing may further comprise a change in transparency of the layer.

The change of appearance of the electrical conducting layer may further comprise a change in colors.

The change of appearance of the electrical conducting layer may further comprise a change in reflection.

The change of appearance of the electrical conducting layer may further comprise a change in pattern.

The casing may further comprise that the layer covers the whole outer surface of the casing.

The casing may further comprise an additionally layer of pressure sensitive material.

The casing may additionally comprise additional layers of electrical conducting material, wherein each additional layer are controlled by an individual control signal and adapted to change its appearance depending on said individual control signal.

The layer of electrical conducting material may further be configured to retain its appearance if no change in the control signal is received.

The layer of electrical conducting material may further be configured to retain its appearance if no control signal is received.

The input signal may further be generated by said pressure sensitive layer as a result of a pressure applied to said pressure sensitive layer.

The input signal may further be generated by a user command.

The portable communication device may further comprise a user interface, wherein the input signal is generated by operating said user interface.

The input signal may further be generated by an external event outside to the portable communication device.

A second aspect of the present invention relates to a method for changing appearance of a casing in a portable communication device comprising at least one layer of electrical conducting material, wherein the layer is connected to an outer surface of the casing, adapted to change its appearance, the method comprising the steps, receiving an input signal, producing a control signal as a result of the received input signal, changing the appearance of the casing as a result of a control signal, and retaining the appearance of the casing.

A third aspect of the present invention relates to a computer-readable medium having computer-executable components comprising instructions for changing the appearance of the casing of a portable communication device comprising at least one layer of electrical conducting material, wherein the layer is connected to an outer surface of the casing, adapted to change its appearance, comprising instructions for, receiving an input signal, producing a control signal as a result of the received input signal, changing the appearance of the casing as a result of a control signal, and retaining the appearance of the casing.

Any of the features in the first, second, and third aspect of the present invention above may be combined in any way possible.

### BRIEF DESCRIPTION OF THE DRAWINGS

Further objects, features, and advantages of the present invention will appear from the following detailed description of some embodiments of the invention, wherein some embodiments of the invention will be described in more detail with reference to the accompanying drawings, in which:

FIG. 1 shows the front side of a portable communication device, in this case a mobile phone; and

FIG. 2 shows the backside of a portable communication device, in this case a mobile phone; and

FIG. 3 shows the backside of a mobile phone according to an embodiment of the present invention; and

FIG. 4a shows a front side, the side and the backside of a mobile phone according to an embodiment of the present invention; and

FIG. 4b shows the backside of a mobile phone and an earpiece according to an embodiment of the present invention; and

FIG. 5a shows the arrangement of two different layers of materials according to an embodiment of the present invention; and

FIG. 5b shows the arrangement of three different layers of materials according to an embodiment of the present invention; and

FIG. 5c shows the arrangement of four different layers of materials according to an embodiment of the present invention; and

FIG. 6 shows how three different layers are connected via wires to a circuit board housing several circuits according to an embodiment of the present invention; and

FIG. 7 shows a flowchart describing the process of changing the appearance of the casing of a mobile communication device according to an embodiment of the present invention; and

FIG. 8 shows a block diagram of a computer-readable medium with computer-executable components comprising instructions for changing the appearance of the casing of a portable communication device communicating with according to an embodiment of the present invention.

### DETAILED DESCRIPTION

Embodiments of the present invention relate, in general, to the field of portable communication devices and, in particularly, to user-modifiable casings in such devices.

A preferred embodiment relates to a portable communication device, such as a mobile phone, including a user-modifiable casing. However, it should be appreciated that the invention is as such equally applicable to electronic devices which do not include any radio communication capabilities. Examples of such devices may for instance be global positioning system devices, laptops (such as standard, ultraportable, and micro laptops), handheld computers, gaming devices, accessories to mobile phones, keyboards, etc. However, for the sake of clarity and simplicity, most embodiments outlined in this specification are related to mobile phones.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

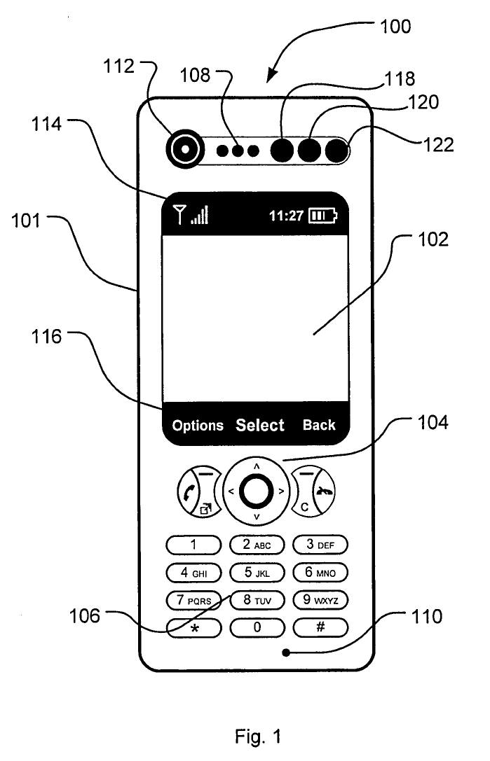

FIG. 1 shows the front side of an ordinary portable communication device, in this case a mobile phone 100, comprising a casing 101, a display area 102, and means 104 for navigating among items (not shown) displayed in the display area. The casing 101 may be made of any type of casing material such as painted or not painted plastic, metal, glass, polymer material, or a combination thereof. The display area 102 may comprise a status indication area 114 and one or more softkey bars 116. The status indication area 114 may for example include symbols for indicating battery status, reception quality, speaker on/off, present mode, time and date, etc. The status indication section is not in any way limited to include the symbols and the functions presented herein. The softkey bar 116 is operable using the navigation means 104 or, if using a touch sensitive screen, by tapping the softkey directly with a pen-like object, a finger, or other body part. The functions of the softkeys are not limited by the functions indicated in the figure. Neither are the placements of the softkey bar 116 and the status indication area 114 limited to be placed at the bottom and the top of the screen, as shown in the example. The navigation means 104 can be a set of buttons, a rotating input, a joystick, a touch pad, a multidirectional button, but can also be implemented using a touch sensitive display, wherein the displayed items directly can be tapped by a user for selection, or be voice activated via a headset or a built-in microphone. The mobile phone 100 can also comprise other elements normally present in such a device, such as a keypad 106, a speaker 108, a microphone 110, a camera 112, a photo sensor 118 (e.g. ambient light), a infrared light (IR) sensor 120, infrared light emitting diode 122 (IR LED), processing means (not shown), memory means (not shown), one or more accelerometers (not shown), a vibration device (not shown), an AM/FM radio transmitter and receiver (not shown), a digital audio broadcast transmitter and receiver (not shown), a Bluetooth device (not shown), an antenna module (not shown), etc.

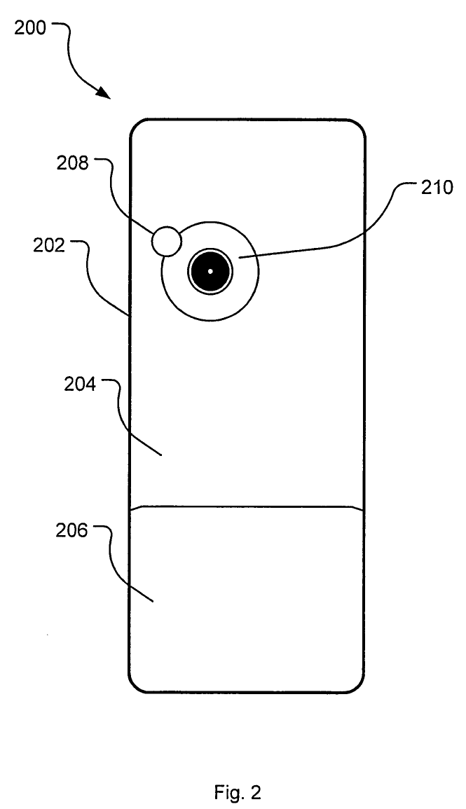

FIG. 2 shows the backside of an ordinary mobile phone 200 comprising a casing 202. In this case the upper part of the casing 204 is fixed while the lower part of the casing 206 is removable fixed. The lower casing part 206, covering the power source (not shown) of the portable communication device, may be referred to as a battery hatch. The backside may also house a camera module 210, comprising a lens and a shutter, and a small mirror 208 used for aiming when photographing oneself. The backside may also house other device not shown in the figure such as a speaker, microphone, buttons, selection wheels, and other gadgets used when operating the device.

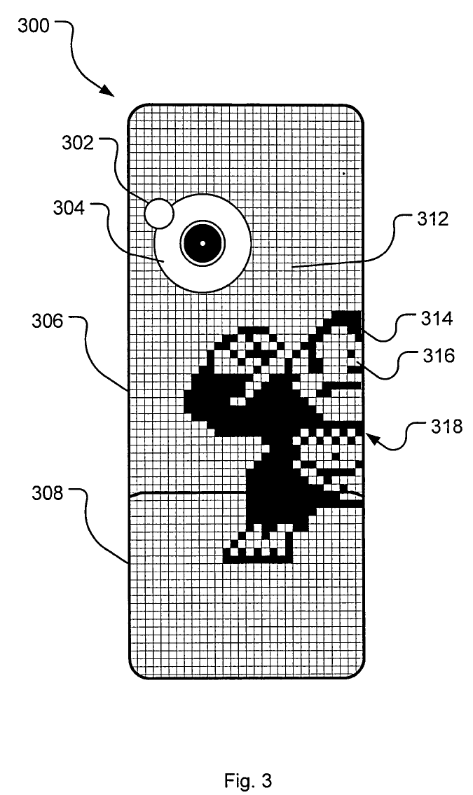

FIG. 3 shows an embodiment of the present invention. The figure shows a similar backside of a mobile phone as shown in FIG. 2, housing a mirror 302, a camera module 304, a fixed upper casing part 306 and a removable lower casing part 308. In contrast to the mobile phone backside 200 shown in FIG. 2, the backside 300 in FIG. 3 shows an embodiment of the present invention wherein the whole outer casing 306, 308 of the backside of the mobile phone has been covered with an electrical conducting material 312 which are capable of changing its appearance. In this embodiment the electrical conducting material 312 are divided into a multitude of cells in the form of squares 314, 316, wherein each cell or square is capable of change its appearance, in this case its transparency, independently. The change in transparency of the individual squares 314, 316 may in this way give rise to a pattern on the casing 306, 308. For example, if the casing material beneath the electrical conducting material 312 is of a light colour (white) and a square of the electrical conducting material 312 is transparent 316, the light colour may be observed by a user looking at the casing (thus seeing a white square). If the electrical conducting material 312 changes to be non-transparent the light colour beneath the electrical conducting material 312 will be concealed, and a dark square 314 may be observed by a user looking at the casing. By manipulating the transparency of each of the different cells or squares of the electrical conducting material 312, different images, patterns, or markings may be observed by a user looking at the casing. For instance, in the embodiment of the present invention shown in FIG. 3 a half monkey 318 made up of transparent and non-transparent squares may be observed. The half monkey 318 has been created on the casing by adjusting the transparency of the different squares of the electrical conducting material 312 on the casing 306, 308.

The electrical conducting material 312 shown in FIG. 3 may cover the whole of the outer casing of the mobile phone or just one or several parts or patches of the casing of the mobile phone.

The electrical conducting material 312 shown in FIG. 3 may not only be divided into squares, it may be divided into any type of geometrical shape such as for instance circles, bars, triangles, ellipses, octagons, hexagons, pentagons, or any abstract non-symmetrical shape. The size of the shapes may also vary from very small, not observable to the naked human eye, to large shapes observable by the naked human eye.

The appearance of the electrical conducting material 312 shown in FIG. 3 may not only be either fully transparent or non-transparent. The electrical conducting material 312 may in another embodiment assume any degree of semi-transparency between fully transparent and non-transparent. For example, the electrical conducting material 312 may be set to achieve 37% transparency. In this way not only light and dark squares (or the current shape used) may be produced and displayed but also semi-transparent squares appearing as different shades of grey square may be displayed. In this way, for example, a greyscale ranging from white squares (light squares) to black (dark squares) may be achieved. Consequently more elaborate pictures or pattern may be displayed, using the electrical conducting material 312, on the outer casing.

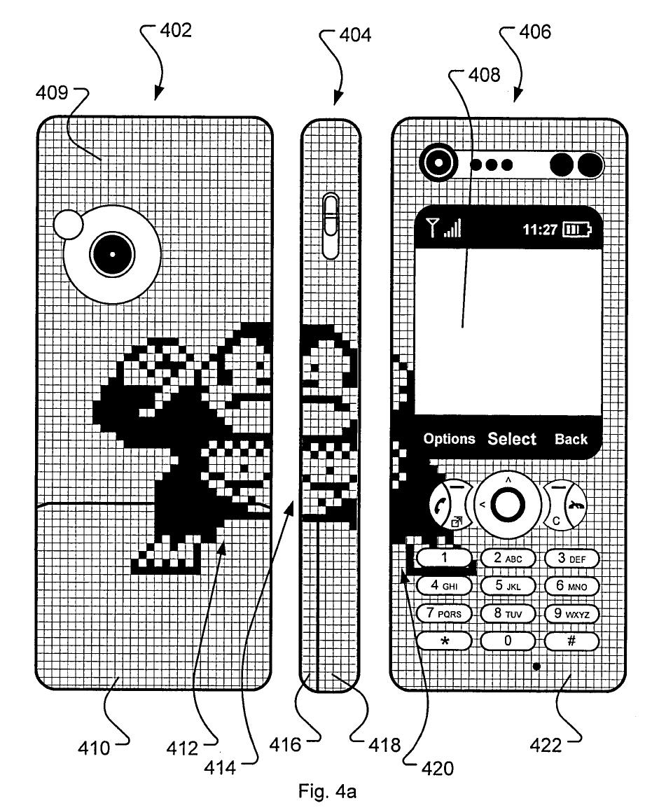

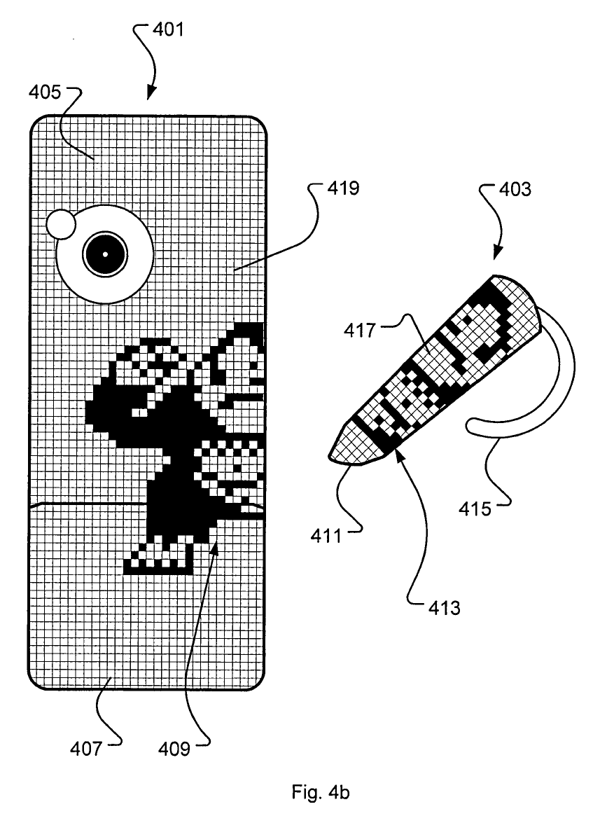

The electrical conducting material 422 may not only be applied to the backside or a specific part of the mobile phone as shown in FIG. 3. The electrical conducting material 422 may be applied to the whole casing, both the backside 402, the front side 406, and the sides 404, as shown in FIG. 4a. In this way a picture or a pattern may be displayed anywhere on the casing of the mobile phone. In the embodiment shown in FIG. 4 a monkey 412, 414, 420 may be displayed covering part of both the fixed 409 and removable 410 part of the backside 402, the fixed 418 and removable 416 part of the side 404, and part of the front side 406 of the casing as shown in FIG. 4a.

In another embodiment the left arm of the monkey, concealed by the display 408 in FIG. 4a, may be displayed by the display 408. In this way the display 408 may act together with the electrical conducting material 422 of the casing and aid in displaying images or patterns otherwise concealed by the display 408.

In one embodiment the electrical conducting material 422 may also be incorporated into or cover buttons, knobs, wheels, and other input and navigation means of the mobile phone.

In another embodiment the electrical conducting material 422 may also be incorporated into or cover the display 408 of the mobile phone. In this way the display 408 may be concealed from the user if the electrical conducting material 422 is made to be non-transparent, and only reviled to the user when made semi- or fully transparent. Also, in this way the electrical conducting material 422 may cooperated with the display in displaying different images.

In another embodiment the inside of the battery hatch (the removable casing part 410, 416 of the mobile phone) may be covered with the electrical conducting material 422, and used to, for instance, display messages or pictograms as instructions or information about the battery or the mobile phone. It may also for instance display the owners contact information if the mobile phone gets lost.

FIG. 4b shows yet another embodiment of the present invention. In this embodiment the electrical conducting material 417, 419 has been applied both to the backside of a mobile phone 419 as well as to the casing surface of an accessory to the mobile phone, which in this case is an earpiece 403. The earpiece comprise of a body part 411 housing a speaker module (not shown), a microphone (not shown), a power source (not shown), a communication device (not shown) such as for instance a Bluetooth device the power source, and a fastening device 415, which goes behind the ear of a user to fastening the earpiece to the user ear. The electrical conducting material 417 on the earpiece 403 acts and can be used in the same way as the electrical conducting material 419 on the casing of the mobile phone 401. Also, when the earpiece 403 is connected, or paired, to the mobile phone 401 the electrical conducting material 417 on the earpiece may be configured to act as an extension of the electrical conducting material 419 on the mobile phone 401. This means that a user may draw on both electrical conducting material surfaces 417, 419 as if it was one continues surface of electrical conducting material. FIG. 4b shows an example where the earpiece is paired with the mobile phone and the pattern of the monkey 409 on the backside of the mobile phone 401 has been extended onto the earpiece thus showing part of the left half of the monkey 413 on the casing of the earpiece 403. Not only static patterns may be extended onto an electrical conducting material on the casing of a second electronic device. Also on accessories dynamic pattern which changes over time may be extended onto a second device such as an earpiece 403. For instance if the user initiates a dynamic pattern on the electrical conducting material on the casing of the mobile phone 401 in the form of a ball bouncing around, the pattern of the ball may travel off the casing of the mobile phone 401 and continue on the casing surface of the earpiece 403.

If the user possesses other electronic devices such as for instance a second mobile phone, a handheld GPS device, a gaming device, a portable personal computer, a stationary computer, a stationary display, a keyboard, a surf-tablet or any other type of electronic device which has been covered with an electrical conducting material, these devices may when paired or in close proximity be incorporated into one large area capable of displaying pattern drawn or designed by one or several users handling the devices.

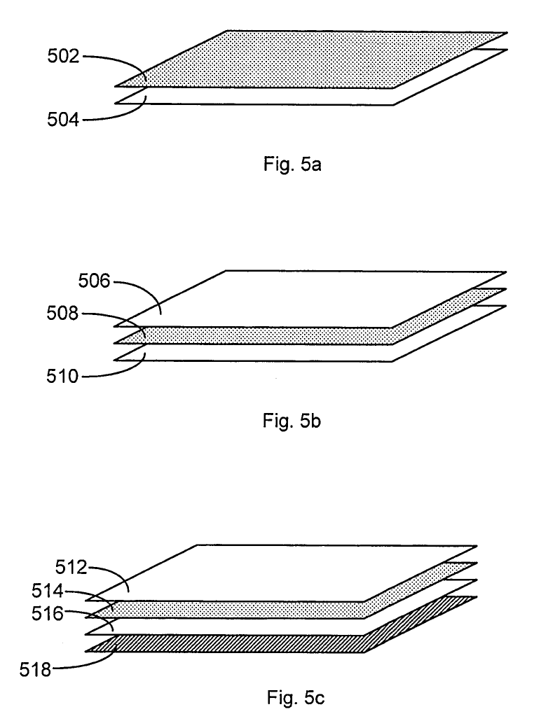

FIGS. 5a-c shows different embodiments describing how the electrical conducting material may be connected to the outer surface of the casing (from hereinafter referred to as just the casing) of a mobile phone.

In an embodiment, shown in FIG. 5a, a single layer of the electrical conducting material 502 is placed on top of the casing, thus forming a mobile phone casing capable of changing its appearance. In another embodiment several layers of electrical conducting material 502 may be placed on top of each other, and then on top of the casing 504. In this way several layers may act together (displaying transparent, semi- or non-transparent patterns) forming intricate patterns or images. Each layer of electrical conducting material 502 may be placed on top of each other in a symmetrical way or in a non-symmetrical way. In this way several skewed (thus being non-symmetrical), in comparison with each other, layers may be able to produce patterns which may be impossible or hard to do using only one layer or several layers in placed on top of each other in a symmetrical fashion.

In another embodiment the different layers of electrical conducting material 502, placed on top of the casing 504, may have different shaped cells. In this way individual layers or a combination of layers being transparent, semi- and/or transparent, and/or reflective may give rise to specific patterns or images. For example, a first layer of electrical conducting material 502 may have cells shaped as plus signs, while a second layer of electrical conducting material 502 may have cells shaped as minus signs. If the two layers are placed on top of each other in a symmetrical fashion both a plus and a minus sign may be generated in the same area of the casing.

In another embodiment one layer of electrical conducting material 502 may be capable of displaying a specific colour when being non-transparent. By combining several layers, where each layer is capable of displaying a specific colour when being non-transparent, a whole palette or a range of colours may be displayed. For example, by stacking a layer capable of displaying the colour green on top of a layer capable of displaying red which is stacked on top of a layer capable of displaying blue, all three colours may be shown on the casing. For instance, if the colour red is to be displayed on the casing the green layer is made transparent and the red layer is made non-transparent (the transparency of the blue layer does not matter since it is under the read layer), thus displaying the colour red. In this way several colours may be displayed by combining several different layers each capable displaying a colour.

In another embodiment the different coloured layers may additionally be capable of being semi-transparent and/or reflective, thus give rise to even more possible combinations resulting in even more intricate patterns and images.

In another embodiment, a single layer of electrical conducting material 502 may be able to produce a range of colours in it self. This may in an embodiment be done by placing three different coloured shapes side-by-side, such as for instance red, green, blue, thus combined producing a specific colour (compare with television). Other colour combinations than the combination red, green, and blue may also be used.

In yet another embodiment, each layer of electrical conducting material 502 may be capable of producing its own light, in a specific colour.

FIG. 5b shows another embodiment of the present invention. In this embodiment one (or several) electrical conducting material 508 may be put on top of the casing 510, and a transparent, semi-transparent, and/or polarized layer 506 may be placed on top of the electrical conducting material 508.

In an embodiment, the top layer 506 may only be a protective layer, protecting the electrical conducting material from wear and tear, while in another embodiment the top layer 506 may act as a filter filtering out specific wavelengths (colours) or reducing glare and reflexes of the surface.

In another embodiment the top layer 506 may be of a material which has been design to be transparent and also dirt, dust, water, and finger print resistant.

In yet another embodiment the top layer 506 may be a pressure sensitive layer capable of registering pressure applied to it. The pressure sensitive layer may also be able to produce an electrical signal which corresponds to the location of the pressure and the absolute (or relative) value of the pressure at that specific location.

FIG. 5c shows another embodiment of the present invention. In this embodiment the top layer 512 may either be a pressure sensitive layer or a protective layer as described above. The second layer 514 may either be one or several layers of electrical conducting material, or a filter layer, or a first or second pressure sensitive layer. The third layer 516 may be a reflective layer, or a homogenously painted layer (a solid colour), or a painted patterned layer (in one or several colours), or a transparent layer, or a first, second, or third pressure sensitive layer. The fourth and bottom layer the casing to which all the other layers are connected (placed upon). By combining different layers with each other different functions and/or appearances of the casing may be achieved.

In an embodiment several pressure sensitive layers may be used simultaneously to form a multi-pressure sensitive surface with a wider range of pressure sensitivity than achieved if only one pressure sensitive layer was used.

In another embodiment, the pressure sensitive layer, discussed in conjunction with the embodiments in FIG. 5a-c above, may be substituted for a proximity sensing layer. The proximity layer, which may be based on a capacitive sensing technique, will detect an object, such as a finger, coming into the proximity of the proximity sensing layer, or layers, on the casing. When the proximity layer detects an object an electrical signal is produced corresponding to the objects size and location relative to the proximity sensing layer.

A layer may also be made out of a piezoelectric material. The piezoelectric layer may be used in any of the embodiments, in any sensible combination, discussed in conjunction with FIGS. 5a-c above.

The layer of electrical conducting material, discussed in conjunction with FIGS. 5a-c above, may be realized using smart glass (or switchable glass), where the smart glass is either a electrochromic device, suspended particle device, or a liquid crystal device, or a combination thereof. The layer of electrical conducting material may also be realized using E-ink technology, bioluminescent technology, electrophoretic technology, electro-wetting technology, organic light emitting diode technology, interferometric modulator technology, surface-conduction electron-emitter technology, NanoChromics Technology, thin-film technology, or any other display technology suitable to implement the present invention.

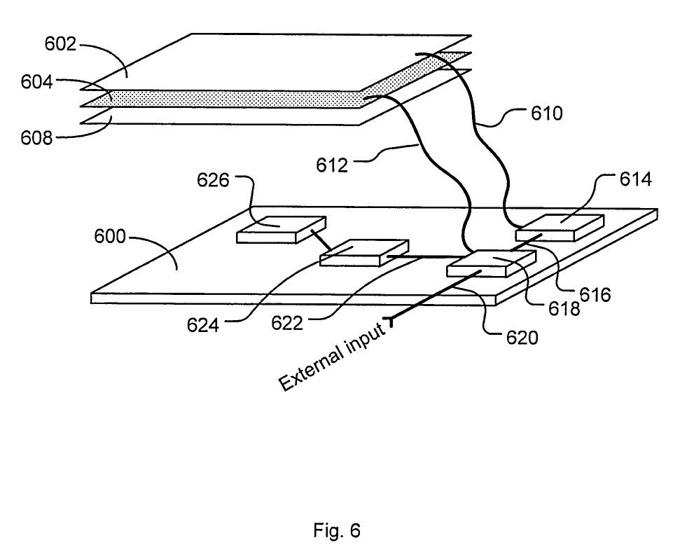

FIG. 6 shows an example of how the different layers discussed in conjunction with FIGS. 5a-c may be connected electronically to the electronic components in a mobile phone or in any other electronic device. In the embodiment shown in FIG. 6, two 602, 604 of the three layers 602, 604, 608 are connected by wires 610, 612 to an electronic circuit board 600 housing a collection of electronic circuits 614, 618, 624, 626 which are connected to each other by wires 622, 616. The top layer 602 may in this embodiment be a pressure sensitive layer, the second or middle layer 604 may be a layer of an electrical conducting material, and the third or bottom layer 608 may be the outer casing of the mobile phone to which the other two layers 602, 604 are connected to. When actuating the pressure sensitive layer 602 (pressing on it with a finger or a pen-like object) a pressure input signal is generated and transmitted trough one or several wires 610 to a control unit 618. The generated input signal may either be sent directly (not shown in the picture) to the control unit 614, or via a pressure sensitivity conversion unit 614 producing a converted signal which then is sent to the control unit 614. The produced input signal may for instance contain the location of the pressure on the layer and the amount of pressure applied to the location. The control unit 618 then interprets the received input signal and produces a control signal which is sent to the layer of electrical conducting material 604 which, for instance, may alter its transparency in a location corresponding to the location where pressure was applied to the pressure sensitive layer 602. In this way a user-modifiable casing has been created. When a user wants to modify the appearance of the casing, the user uses his or hers finger or any other pen-like object to apply pressure on the casing where he or she wants to change the casings appearance. So if the user wants to have a flower on the backside casing of a mobile phone the user just “paints” the flower using a pen-like object directly on the casing which changes the casings transparency so that the painted flower appear on the casing. The width and the look of the pattern painted on the casing may in an embodiment depend on which type of pen-like object used. A small pencil-like object may produce a thin sharp line, while a fingertip may produce a thick more blurred line. Also other types of patterns besides lines may be produced such as for instance a flower pattern may be produced wherever a pen-like object is detected on the casing surface.

In another embodiment, several pen-like objects, such as fingers, may be used on the casing at the same time. The pressure sensitive layer 602 detects that multiple objects presses onto the surface at the same time, and depending on parameters such as the amount of pressure, the size of the depressed area, position on the casing, relative position between the objects pressing down, and/or movement of the objects, assign the objects the same or different characteristics. These characteristics may for instance be that each object will be assigned a specific line width, colour, pattern, an action, etc. In this way the different fingers of the user may for instance be assigned different colours and width, so when the user uses his index finger to draw on the casing the pattern may be thin and coloured blue, while if the user uses his thumb to draw on the casing the pattern may be wide and coloured green. Also, if one or several fingers are moved over the casing, these specific movements may be detected as a gesture. Each gesture may then be assigned a specific action such as enable drawing mode on casing, clear/erase casing, zoom pattern on casing, make a stationary object a dynamic object, share pattern with an accessory or other user, etc.

In another embodiment, an input signal is produced internally in a circuit 626, 624 due to an internal event or a running application. The input signal coming from the internal event or application is sent by one or several wires 622 to the control unit 618. The control unit 618 then interprets the received input signal and produces a control signal which corresponds to the input signal coming from the internally generated event or application. The generated control signal in the control unit 618 is sent by wires 612 to the layer of electrical conducting material 604 which for instance may alter its transparency in a specific location depending on the event or application. In this way a user-modifiable casing has been created. When a user wants to modify the appearance of the casing, the user may for instance start an application in the mobile phone which shows a picture of the backside of the mobile phone on the display of the mobile phone. The user may then draw, using a pen-like object or the some other navigational means, directly on the displayed picture on the mobile phone display showing the backside of the phone. Simultaneously as the user draws on the picture on the mobile phone display the mobile phones backside will change accordingly. In this way the user may change the appearance of the casing of the mobile phone to his or hers liking. Also other applications operated using the user-interface of the mobile phone may be used to modify the pattern of the layer of electrical conducting material 604.

In yet another embodiment, an input signal is produced externally of the mobile phone, for example if a communication signal is received by the mobile phone containing an event. The input signal coming from the external event is sent by one or several wires 620 to the control unit 618. The control unit 618 then interprets the received input signal and produces a control signal which corresponds to the input signal coming from the externally generated event. The generated control signal in the control unit 618 is sent by wires 612 to the layer of electrical conducting material 604 which for instance may alter its transparency in a specific location depending on the externally generated event. In this way a user-modifiable casing has been created. A user may for instances receive a multimedia message from a friend containing a picture. The user may then use the received picture as a template and instruct the mobile phone to change the appearance of the casing to resemble the received picture. In this way, users are able to share different casing modifications with each other and also let the casing show pictures of your favourite cat or friend.

In another embodiment several input signals produced from a user command, the operating of the user-interface or one or several external events, may be used together to change the pattern on the layer of electrical conducting material 604. For instance, if the user draws on the pressure sensitive layer and a sensor detecting the surrounding moisture, temperature, or ambient light level, the two (or more) input signals may be combined in such way that if the temperature outside is low the pattern on the layer of electrical conducting material 604 will be in the form of snowflakes, or if the moisture is detected to be high in the surrounding air the pattern will be in the form of rain drops. In this way several input signals generated from external sensors etc. in combination with internally generated input signals may influence the pattern displayed on the layer of electrical conducting material 604.

Depending on which material that is used for implementing the layer of electrical conducting material 604, a power supply maintaining the change of transparency in the electrical conducting material may or may not be needed. If for instance a material such as smart glass is used, a power supply is not needed to maintain any change in the electrical conducting material. The only time power is need is when the appearance of the layer is to be changed. A pattern in the electrical conducting material does not need any additional power or any other type of update signal to be retained. This allows for a very power efficient solution.

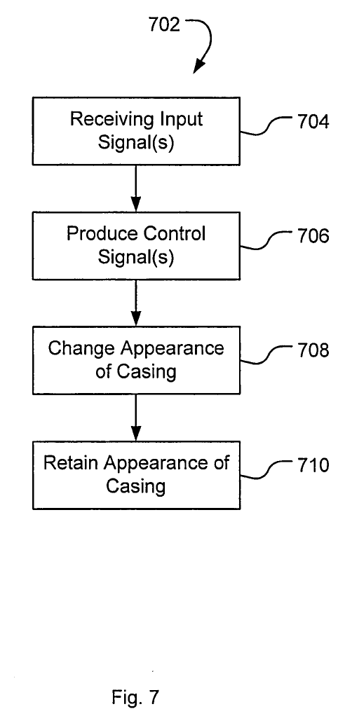

FIG. 7 shows a flowchart 702 according to an embodiment of the present invention. The flowchart 702 describes one method of how the changing of appearance of the mobile phones casing may be done. In the first step 704 an input signal(s) is received. The input signal(s) may be generated by actuating of one or several pressure sensitive layers, an internal event or application running in the mobile phone, a received external event to the mobile phone, e.g. the reception of an alarm signal via Bluetooth or some wireless communication technique, signal coming from a sensor, or some combination thereof. The received input signal(s) are interpreted, converted, or passed through an algorithm or application thus producing a control signal(s) 706. The produced control signal(s) 706 are sent to one or several layers of electrical conducting material changing this or these layers appearance in a way described above resulting in that the appearance of the casing 708 is changed. The appearance of the casing is retained 710 until another control signal(s) is produced and received. The appearance is retained even if the battery power runs out, thus making it independent of the power supply to retain its appearance.

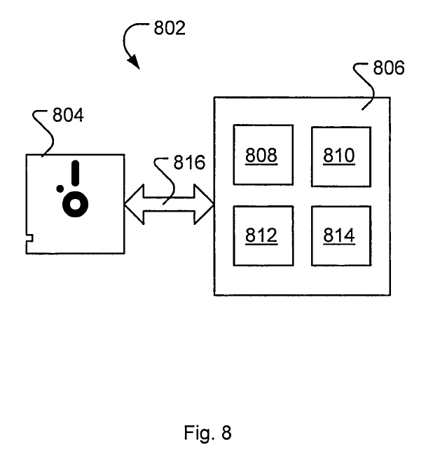

FIG. 8 shows a computer-readable medium 804 having computer-executable components comprising instructions for changing the appearance of the casing of a mobile phone. The computer readable medium 804 may be housed internally or externally of the mobile phone. The computer readable medium 804 may house instructions for performing the method described in conjunction with FIG. 7, i.e. receiving an input signal, producing a control signal as a result of the input signal received, changing the appearance of the casing as a result of a control signal, and retaining the appearance of the casing. The computer readable medium 804 may communicate, via an interface 816, such as a data bus, with other hardware or software blocks 806 in the mobile phone housing components or programs that are capable of receiving an input signal 808, producing a control signal as a result of the input signal received 810, changing the appearance of the casing as a result of a control signal 812, and retaining the appearance of the casing 814.

The pattern or picture displayed by the electrical conducting material in the above embodiments may either be static or dynamic. A static pattern will not change until the user or a specific event initiates a change of it, while a dynamic pattern may change over time without the involvement of the user or an internal or external event. For example, if the user draws a ball on the casing, the ball may over time travel randomly over the whole casing surface bouncing when reaching an edge or another object on the phone such as a button or the display. If several electronic devices coated with the electrical conducting material have been paired together, meaning that they are in communication with each other, a dynamic pattern such as the ball may move from one device onto another device as if the cover on all devices belonged to a single cover.

The present invention, described in detail in the above embodiments, will provide the user with a user-configurable casing which is highly modifiable and which may be both cheaper and more durable compared to using exchangeable covers and/or stickers. The present invention is also very power conservative since, if implemented using an electrochromic material such as smart glass, only consumes a negligible amount of power when changing its pattern.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. Casing for a portable communication device, comprising; at least one layer of an electrical conducting material adapted to change its appearance, wherein said layer is connected to an outer surface of said casing;
a control unit adapted to receive an input signal and as a result produce a control signal;
wherein said layer is adapted to receive said control signal and to change its appearance depending on said control signal, and thereby change the appearance of said casing.

2. The casing according to claim 1, wherein said layer of electrical conducting material comprise of a number of individual cells, wherein each individual cell is capable of changing its appearance individually depending on said control signal.

3. The casing according to claim 1, wherein said change of appearance of the casing comprises a change in transparency of said layer.

4. The casing according to claim 1, wherein said change of appearance of the electrical conducting layer comprises a change in colors.

5. The casing according to claim 1, wherein said change of appearance of the electrical conducting layer comprises a change in reflection.

6. The casing according to claim 1, wherein said change of appearance of the electrical conducting layer comprises a change in pattern.

7. The casing according to claim 1, wherein said layer covers the whole outer surface of the casing.

8. The casing according to claim 1, wherein the casing additionally comprises a layer of pressure sensitive material.

9. The casing according to claim 1, wherein the casing additionally comprises additional layers of electrical conducting material, wherein each additional layer are controlled by an individual control signal and adapted to change its appearance depending on said individual control signal.

10. The casing according to claim 1, wherein said layer of electrical conducting material is configured to retain its appearance if no change in the control signal is received.

11. The casing according to claim 1, wherein said layer of electrical conducting material is configured to retain its appearance if no control signal is received.

12. The casing according to claim 1, wherein the input signal is generated by said pressure sensitive layer as a result of a pressure applied to said pressure sensitive layer.

13. The casing according to claim 1, wherein the input signal is generated by a user command.

14. The casing according to claim 1, wherein the portable communication device comprises a user interface, wherein the input signal is generated by operating said user interface.

15. The casing according to claim 1, wherein the input signal is generated by an external event outside to the portable communication device.

16. Method for changing appearance of a casing in a portable communication device comprising at least one layer of electrical conducting material, wherein said layer is connected to an outer surface of said casing, adapted to change its appearance, the method comprising the steps;
receiving an input signal;
producing a control signal as a result of the received input signal;
changing the appearance of the casing as a result of a control signal; and
retaining the appearance of the casing.

17. A computer-readable medium having computer-executable components comprising instructions for changing the appearance of the casing of a portable communication device comprising at least one layer of electrical conducting material, wherein said layer is connected to an outer surface of said casing, adapted to change its appearance, comprising instructions for;
receiving an input signal;
producing a control signal as a result of the received input signal;
changing the appearance of the casing as a result of a control signal; and
retaining the appearance of the casing.
